(19) United States
(12) Patent Application Publication
(10) Pub. No.: US 2024/0161448 A1
(43) Pub. Date: May 16, 2024

(54) System and method for object recognition using whole-image triangulation

(71) Applicant: Andrew Steven Naglestad, Woodland Hills, CA (US)

(72) Inventor: Andrew Steven Naglestad, Woodland Hills, CA (US)

(21) Appl. No.: 18/388,398

(22) Filed: Nov. 9, 2023

Related U.S. Application Data
(60) Provisional application No. 63/425,673, filed on Nov. 15, 2022.
(60) Provisional application No. 63/433,000, filed on Dec. 15, 2022.
(60) Provisional application No. 63/439,137, filed on Jan. 15, 2023.

(51) Int. Cl. G06V 10/44; G06V 10/50; G06V 10/77; G06V 10/776; G06V 10/82

(52) U.S. Cl. CPC G06V 10/454; G06V 10/507; G06V 10/7715; G06V 10/776; G06V 10/82

(57) ABSTRACT

A system and method for performing object recognition using chords is disclosed, A chord is a feature representing the distance between edge pixels and/or the angle of a line segment connected to edge pixels. The object recognition system preferably includes: an edge detector, a plurality of transforms, a chord generator, and a summing circuit. The edge detector is configured to detect a plurality of edge pixels in the acquired image and reference image. Each transform is associated with a scale which is the ratio of an input chord length and an output chord length for associated with the transform. The chord generator is configured to generate a first plurality of chords representing a point in the acquired image, and a second plurality of chords representing a point in the reference image. The summing circuit is configured to: determine, for each of a plurality of scales, the number of chords from the second plurality of chords that have a counterpart chord among the first plurality of chords, and output a recognition signal if and when the number exceeds a predetermined threshold for one of the plurality of scales. A scale selector module may be employed to sweep through a range of scales and selectively activate a subset of the plurality of transforms whose characteristic scale is equal to the instantaneous scale while sweeping through the range of scales. The invention may be used to accelerate the training and accuracy of a convolutional neural network.

### CROSS-REFERENCE TO RELATED APPLICATION (S)

This application claims the benefit of U.S. Provisional Patent Application Ser. No. 63/425,673 filed Nov. 15, 2022, U.S. Provisional Patent Application Ser. No. 63/433,000 filed Dec. 15, 2022, and U.S. Provisional Patent Application Ser. No. 63/439,137 filed Jan. 15, 2023, all of which are hereby incorporated by reference herein for all purposes.

### TECHNICAL FIELD

The invention generally relates to a system and method for performing object recognition. In particular, the invention performs object recognition based on the distance and/or angle between pairs of edge pixels in an input image compared the distance and/or angle between pairs of pixels in a model of a known object.

### BACKGROUND

The pinnacle of object recognition systems is the human brain. We are capable of recognizing people, objects, and places despite changes in scale, orientation, lighting, color, shape, context, etc. Moreover, we can perform recognition in under 200 milliseconds with little variation. Amazingly, the time required to recognize an object does not increase with the number of objects seen over time. Even objects from our childhood, objects last seen decades ago, can be recognized quickly and effortless, as if they were last seen days ago. In addition to recognizing objects, we tend to notice even minute changes in the appearance of those objects. The human visual system is therefore extremely robust, extremely precise, and extremely flexible at the same time. To date, however, no man-made system comes close to matching the performance of the human brain.

Currently, the best man-made system may be the convolutional neural network (CNN), which employ countless filter kernels to extract contours and combine them into shapes. While useful, CNN's do not appear to operate like the human brain. For example, CNNs require many examples of an object for training, back propagation to learn, and massive levels of matrix multiplication. As such, CNNs appear biologically-possible but not biologically-plausible.

There is, therefore, a need for an object recognition system that can perform robust object recognition without massive training and computational resources.

### SUMMARY

The invention features a novel system and method for performing object recognition using chords. A chord represent the distance between to edge pixels and/or the angle of a line segment connected two edge pixels. Using chords, the system can match hub pixels in the acquired image with hub pixels in the reference image, determine the relative scale of an object represented in an acquired image compared to a reference image, and determine the relative orientation of the object represented in the acquired image relative to the reference image.

In one embodiment, the object recognition system comprises: an edge detector, a plurality of transforms, a chord generator, and a summing circuit. The edge detector is configured to detect a plurality of edge pixels in the acquired image and reference image. Each transform is associated with an input chord length and an output chord length, as well as a scale which is the ratio of output chord length and input chord length. The chord generator is configured to generate features consisting of a first plurality of chords corresponding to a point in the acquired image and a second plurality of chords corresponding to a point in the reference image. The first plurality of chords are couped to transformers based on their input chord length, and the second plurality of chords are couped to transformers based on their output chord length. The summing circuit is configured to: determine, for each of a plurality of scales, the number of chords from the second plurality of chords that have a counterpart chord among the first plurality of chords, and output a recognition signal if and when the number for one of the plurality of scales exceeds a predetermined threshold.

Although optional, the object recognition system may further include a scale selector module configured to sweep through a range of scales and activate a subset of the plurality of transforms whose characteristic scale is equal to the instantaneous scale while sweeping through the range of scales. The system may also include (a) a first data bus connecting each of the first plurality of chords with at least one of the plurality of transforms such that the length of the chord is substantially equal to the input chord length characterizing the transform; and a second data bus connecting each of the second plurality of chords with at least one of the plurality of transforms such that the length of the chord is substantially equal to the output chord length characterizing the transform. Moreover, the chord generator may comprise a plurality of AND gates, where each AND gate is configured to output a “true” signal if a first pixel input and second pixel input are both edge pixels.

In a second embodiment of the invention, the system comprises: plurality of transforms, a feature detector, and a summing circuit. Each transform is associated with (a) an input chord length encoded by a data line on a first data bus, and (b) an output chord length encoded by a data line of a second data bus. The ratio of the input and output chord lengths yields a scale, and that scale associated with the transform for purposes of selective activation of the transform and selective output of the transform. The feature detector is configured to generate: a first set of features consisting of a first plurality of chords extracted from the acquired image, and a second set of features consisting of a second plurality of chords extracted from the reference image. Each of the first plurality of chords is coupled to at least one of the plurality of transforms such that the length of the chord is substantially equal to the length associated with the transform input to which it is connected. Similarly, each of the second plurality of chords is coupled to at least one of the plurality of transforms such that the length of the chord is substantially equal to the length associated with the transform output to which it is connected. The summing circuit is configured to output the number of the first plurality of chords that map to one of the second plurality of chords via a transform for a current scale, i.e., an instantaneous scale, where the scale characterizing the transform is equal to current scale. The summing circuit may include one or more pulse counters for counting signals from the second plurality of chords, in some embodiments, the summing circuit includes an analog to digital converter and plurality of capacitors for integrating signals from the second plurality of chords.

Although optional, the system may further include a scale selector module configured to: select the current scale from a sequence comprising a plurality of scales; activate any of the plurality of transforms characterized by a scale equal to the current scale. The summing circuit then outputs the number of input chords that map to an output chord for each scale of the sequence of scales. Instead of sweeping through a range of scales, the system in some embodiments modulates the outputs of the transforms using one of a range of modulation frequencies, one frequency for each of the plurality of scales. A bandpass filter may be employed to pass the outputs of a portion of the plurality of transforms if and when those outputs are characterized by a common modulation frequency and the number of outputs is maximal. The object recognition system may further include a data bus to connect each of the second plurality of chords with at least one of the plurality of transforms, and another data bus to connect each of the first plurality of chords with at least one of the plurality of transforms.

The invention in some embodiments is a method of performing object recognition. The method includes: generating a first plurality of chords, each of the first plurality of chords being coupled to at least one of the plurality of transforms where the length of the chord is substantially equal to the input chord length associated with the transform; generating a second plurality of chords, each of the second plurality of chords being coupled to at least one of the plurality of transforms where the length of the chord is substantially equal to the output chord length associated with the transform; generating an estimated scale for a plurality of chord pairs, each chord pair comprising one of the first plurality of chords and one of the second plurality of chords; selecting one of a plurality of scales within a range of scales; determining the number of chord pairs activated by or correspond to the selected scale; and outputting a recognition signal if and when the number exceeds a predetermined threshold. In some embodiments, the method further includes the step of generating an estimated rotation angle for each of the plurality of chord pairs; and determining a number of chord pairs corresponding to said one of the plurality of scales and one of the plurality of estimated rotation angles.

### BRIEF DESCRIPTION OF THE DRAWINGS

The present invention is illustrated by way of example and not limitation in the figures of the accompanying drawings, and in which:

FIG. 1 is a functional block diagram of an object recognition system, in accordance with the first preferred embodiment;

FIG. 2 is a flow chart of the overall object recognition process, in accordance with the first preferred embodiment;

FIG. 3A is an image of the edges of a key;

FIG. 3B is a diagrammatic representation of a set of chords of a model of a key; in accordance with the first preferred embodiment;

FIG. 3C is a diagrammatic representation of a set of chords of an acquired image of a key at a new scale and rotation angle, in accordance with the first preferred embodiment;

FIG. 4 is a flow chart of the method of determining the object scale and orientation, in accordance with the preferred embodiment;

FIG. 5 is a vote table for logging votes based on an estimated scale and rotation angle, in accordance with the preferred embodiment;

FIG. 6 is a correlation table associating hub pixels in a reference image to hub pixels in an acquired image;

FIG. 7A is a chord table indicating the chord length between pairs of pixels in the reference image, in accordance with the preferred embodiment;

FIG. 7B is a chord table indicating the chord length between pairs of pixels in the acquired image, in accordance with the preferred embodiment;

FIG. 8 is a diagrammatic representation of a circuit for summing votes over a range of scales and rotation angles, in accordance with the preferred embodiment;

FIG. 9 is a diagrammatic representation of a circuit for performing object recognition, in accordance with a second preferred embodiment;

FIG. 10A is a diagrammatic representation of a crossbar switch configured to sweep through a range of scales, in accordance with the second preferred embodiment;

FIG. 10B is a diagrammatic representation of digital output signals from a crossbar switch as it sweeps through a range of scales, in accordance with the second preferred embodiment;

FIG. 11 is a diagrammatic representation of a circuit for performing object recognition, in accordance with a third preferred embodiment;

FIG. 12 is a flowchart of a method of performing object recognition using a crossbar switch and transforms, in accordance with a preferred embodiment of the present invention;

FIG. 13 is a diagrammatic representation of a circuit for performing object recognition, in accordance with a fourth embodiment; and

FIG. 14 is a functional block diagram of an object recognition system with an invariance preprocessor and convolutional neural network, in accordance with a fifth preferred embodiment.

### DETAILED DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The preferred embodiment of the present invention includes a system and method for performing object recognition based on all, or many, of the edge pixels in a reference image and acquired image. The reference image also referred to as the “known” image—depicts a known object while the acquired image—sometimes referred to herein as the “input” image, “test” image, or “unknown” image depicts an unknown object to be identified. The system and method employ a technique referred to herein as Whole-image triangulation (WIT) to perform object recognition using the reference and acquired images after edge detection. The triangulation of edge pixels relative to all the object edges enables the object to be recognized based on the overall shape of the object, thus avoiding the limitations that plague techniques based on gradients of localized features alone and layers of CNN filter kernels.

The distances between numerous pairs of edge pixels in an acquired image are compared to and matched with the distances between numerous pairs of edge pixels in a reference image or model. The distance between any two edge pixels, represented by an imaginary line, is referred to herein as a “chord”. A chord is characterized by a length and/or orientation angle. A chord as used herein is a “feature” and the scale of one feature relative to another is easily determined from the ratio of the chord lengths in cartesian coordinates, or determined using subtraction when the lengths are represented as logarithmic values.

The position of each edge pixel relative to other edge pixels is determined from the chords radiating from a particular edge pixel, referred to herein as a “hub pixel”, to a plurality of other edge pixels, referred to herein as “spoke pixels”, in the image. A chord that links a hub pixel to a spoke pixel is referred to herein as a “primary chord” while a chord linking two spoke pixels in referred to herein as a “secondary chord”. In the aggregate, the set of primary chords relating every hub pixel to a large number of spoke pixels enables the position of the hub pixel to be estimate with a high degree of accuracy. The set of secondary chords can, in turn, be used as verification of the estimates generated by the primary chords. When the primary chords associated with one or more hub pixels are matched and then verified with the secondary chords, the scale and orientation of an object can also be determined with a high level of accuracy, thus enabling robust object recognition.

A functional block diagram of the WIT system is shown in FIG. 1. The WIT system 100 includes a processor 110 configured to perform high-pass filtering, i.e., edge detection, on the acquired image received from a camera, a processor 120 configured to extract the edge pixels from the image; a processor 130 configured to generate chords from the edge pixels, a processor 140 configured to compute the scale and/or rotation angles from chords in the acquired image and chords in a reference image, a processor 150 configured to generate votes indicating the number of matching primary chords at a particular scale and/or rotation angle, a processor 160 configured to determine a hub pixel in the acquired image that best matches a hub pixel in the reference image, and then determine the spoke pixels in the acquired image that best match the spoke pixels in the reference image, a processor 170 configured to validate the pixel matches based upon the secondary chords in the acquired image and the secondary chords between counterpart spoke pixels in the reference image for the computed scale and/or rotation angle; and a processor 180 configured to compute a similarity metric characterizing the quality of the matching hub pixels based on the set of chords tor the acquired image and counterpart chords from the reference image. The similarity metric, which is based on the distance between the pairs of pixels of the reference image as compared to the distance between pairs of edge pixels in the acquired image, may be used to measure the quality of the match between the object in the acquired image and the object in the reference image.

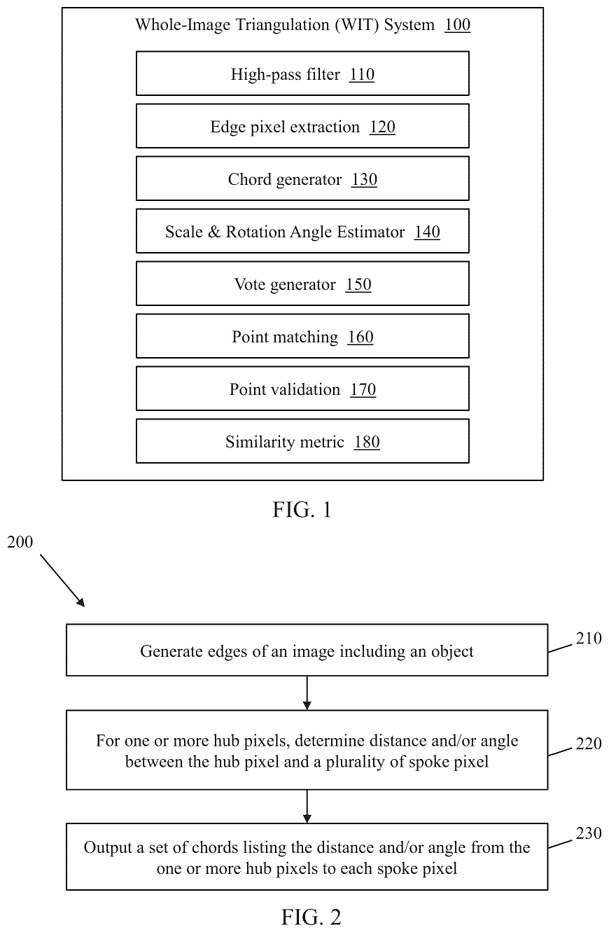

Illustrated in FIG. 2 is a flowchart of the process of generating chords from a high-pass filtered image, in accordance with the preferred embodiment of the present invention. An image is first received or otherwise acquired from a camera on board a robot or autonomous vehicle, for example, and provided as input to the high-pass filter processor 110. The processor 110 then generates 210 or otherwise detects the edges of the object, including the external perimeter of the object as well as internal edges. The high-pass filtered image is a binary image where the edges of the object depicted in the image are represented with a value of one (“1”) while non-edge pixels are represented with a value of zero (“0”). These edge pixels may be detected using a Canny filter or Sobel filter, for example. The binary image is provided as input to the chord generator 130.

The chord generator 130 then generates 220 a set of primary chords for one or more hub pixels. Each primary chord characterizes the distance and/or orientation angle of an imaginary line segment from a first edge pixel, i.e., a hub pixel, to a second edge pixel, i.e., a spoke pixel. For an image comprising N edge pixels, the set of features radiating from a particular hub pixel includes N−1 chords, one for each spoke pixel. Each chord is characterized by a length and/or orientation angle. The angle may range from zero to or zero to 2π depending on the application. Note, each pixel can be labeled as a hub pixel and the corresponding set of chords acquired for the associated spoke pixels. The process is repeated for one or more hub pixels and the set of corresponding chords provided 230 as input to the scale and rotation angle estimator 140.

The process of extracting the chords for one or more hub pixels is repeated for one or more reference images in the same manner as the acquired image described above.

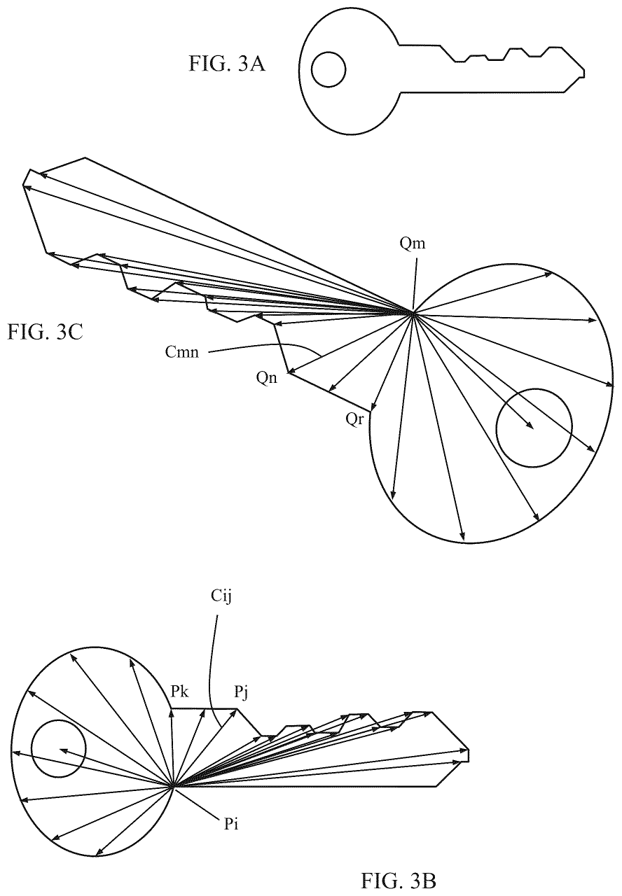

Illustrated in FIG. 3A is an example of an object, namely a common key, that can be modeled and subsequently recognized using the WIT system. Illustrated in FIG. 3B is a reference image showing the same key together with a plurality of chords superimposed on the key. The set of chords connect a hub pixel Pi with a plurality of spoke pixels include, for example, pixel Pj and Pk. The chord spanning from the hub pixel Pi to spoke pixel Pj is labeled Cij and the chord spanning from the hub pixel Pi to spoke pixel Pk is labeled Cik,

FIG. 3C illustrates the acquired image of the same key after high-pass filtering. The key in the acquired image, after high-pass filtering, is generally a line drawing showing the exterior and interior edges of the key. The representation of the key in the reference image and the acquired image are substantially identical except for the fact that the key depicted in the acquired image is characterized by a larger scale and non-zero rotation angle compared to the key depicted in the reference image. The acquired image includes a plurality of chords connecting pairs of edge pixels superimposed on the image of the key. The set of chords shown in FIG. 3C include a hub pixel Qm and a plurality of spoke pixels including Qn and Qr. The chord spanning from the hub pixel Qm to spoke pixel Qn is labeled Cmn, and the chord spanning from hub pixel Qm to spoke pixel Qr is labeled Cmr.

The chord Cmn in FIG. 3C is the “counterpart” to chord Cij in FIG. 3B. That is, chord Cij maps to chord Cmn under a geometric transformation, T(Q,P), characterized by a scale S and rotation angle A where P represents the reference frame of the key in the reference image and Q represents the reference frame in the acquired image. As described below, the present invention uses the set of primary chords radiating from hub pixel Pi and primary chords radiating from hub pixel Qm, for example, to estimate the scale and rotation angle parameters that yield the proper transformation T(Q,P) from the unknown object space in FIG. 3C to the known object space in FIG. 3B.

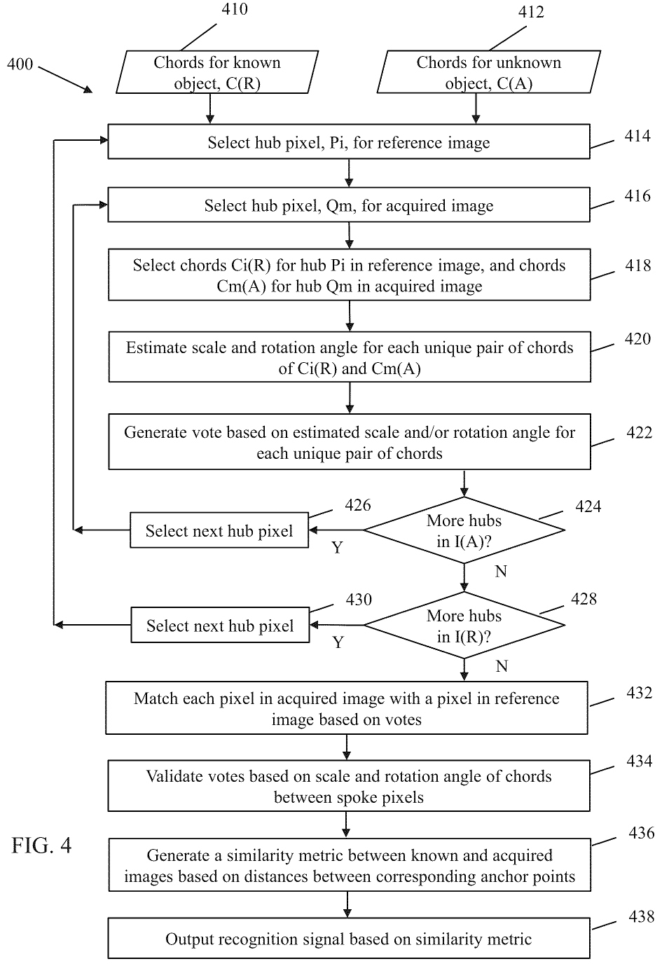

Illustrated in FIG. 4 is the process of recognizing an object from the reference image in the acquired image with arbitrary scale and rotation angle. To start, the WIT system receives 410 the set of chords C(R) for a plurality of hub pixels in the known object depicted in the reference image. Similarly, the system receives 412 the set of chords C(A) for at least one hub pixel of the unknown object depicted in the acquired image.

Next, the WIT system selects or otherwise designates 414 one of the hub pixels Pi in the reference image. Similarly, the system selects or designates 416 one of the hub pixels Qm in the acquired image for purposes of executing steps of the loop described below.

The WIT system then selects 418 a first set of primary chords that radiate from the hub pixel Pi to the spoke pixels in the reference image. The first set of chords radiating from hub pixel Pi is referred to herein as Ci(R). If the binary version of the reference image includes N pixels having a value of “1”, then the number of chords is N−1, Some of the N−1 chords Ci(R) are depicted as vectors in the illustration of the key in FIG. 3B. Similarly, the system selects 418 a second set of primary chords that radiate from the hub pixel Qm to the spoke pixels in the acquired image. The second set of chords radiating from hub pixel Qm is referred to herein as Cm(A). Some of the chords Cm(A) are depicted as vectors in the illustration of the key in FIG. 3C.

The WIT system then estimates 420 a relative scale and relative angle based on the chords from the reference image as compared to the chords from the acquired image for each pair of chords. For a given chord in the reference image Cij(R) and given chord in the acquired image Cmn(A), the estimated scale is given by Cij(R)/Cmn(A) and the estimated rotation angle is the orientation angle of Cmn(R) minus the orientation angle of Cij(A).

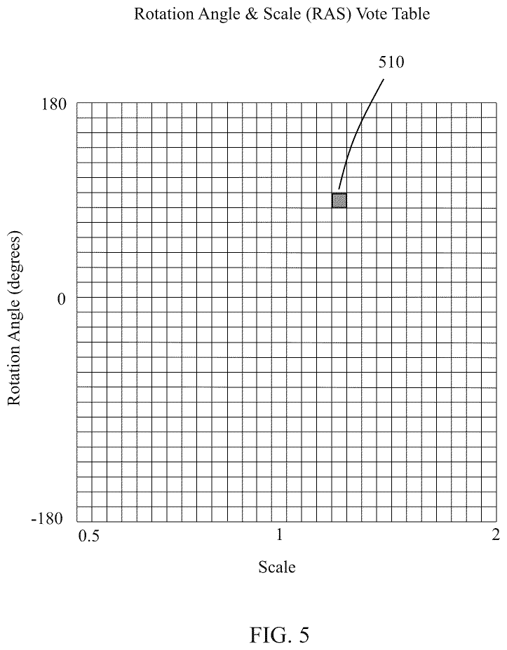

For every unique pair of chords Cmn(A) and Cij(R), the WIT system estimates a scale and/or rotation angle. The scale and rotation angle are used as the indices into a table to increment a vote count associated with that particular estimate of scale and rotation angle. The table is referred to herein as the rotation angle and scale (RAS) vote table, which is shown in FIG. 5. In the RAS vote table, the rotation angle varies from −180 to 180 and the scale ranges from 0.5 to 2.0, although these ranges may vary based on the degree of variation exhibited in each particular application of the invention. As shown in FIG. 5, the vote count at table element 510 is retrieved and incremented 422 to reflect a probability that this rotation angle and scale corresponds to the transform needed to map chord Cmn(A) to chord Cij(R).

This process of calculating 420 a scale and a rotation angle, and incrementing 422 the corresponding vote, is repeated for each unique pair of primary chords, each chord pair comprising one primary chord extracted from the acquired image and one primary chord from the reference image. In some embodiments, less than all chord pairs are computed to increase speed, although there is a tradeoff between speed and accuracy.

Once the votes have been tabulated for the particular pair of hub pixels, Pi and Qm, the process proceeds to decision block 424. If there are additional hub pixels in the acquired image I(A) to process, decision block 424 is answered in the affirmative and the next hub pixel selected 426. Similarly, if there are additional hub pixels in the reference image I(R), decision block 428 is answered in the affirmative and the next hub pixel selected 430.

The process of calculating 420 scales and/or rotation angles and generating 422 votes in a RAS vote table is repeated for each unique pair of hub pixels. When the process of calculating 420 scales/rotation angles and generating 422 votes in a RAS vote table has been executed for each unique combination of reference image hub pixel and acquired image hub pixel, decision block 428 is answered in the negative and the process exits this nested loop.

In step 432, the WIT system matches one or more huh pixels in the acquired image with a hub pixel in the reference image. That is, when the object in the acquired image and the reference image are the same, hub pixels in the acquired image “match” hub pixels in the reference image. Two hub pixels match if and when (a) the vote count in one element of the RAS vote table is maximal across all the RAS vote tables generated in the nested loop above and (b) the maximal vote count exceeds a predetermined threshold. This peak in the RAS vote table occurs because many or all of the primary chords associated with the particular hub pixel in the acquired image have a counterpart chord associated with the counterpart hub pixel in the reference image, thus producing a large vote count at the same scale and rotation angle. Setting aside noise, the height of the peak is generally equal to the number of primary chords that radiate from a point (Pi or Qm) in either the reference image or acquired, which ever depicts a smaller version of the object.

Moreover, if and when the object in the acquired image matches the object in the reference image, multiple huh pixels in the acquired image have a counterpart hub pixel in the reference image. In some embodiments, the RAS vote tables for matching pairs of hub pixels are added or averaged together. When added, the peaks in the respective tables coincide to produce an even larger peak with a higher signal to noise ratio.

In contrast, when the object depicted in the reference image and acquired image are different, or the hub pixel in the reference image corresponds to a different hub pixel in the acquired image, the RAS vote table will generally exhibit noise with little or no discernable peak. Noise generally takes the form of a slowly varying, i.e., low frequency, baseline across the RAS vote table.

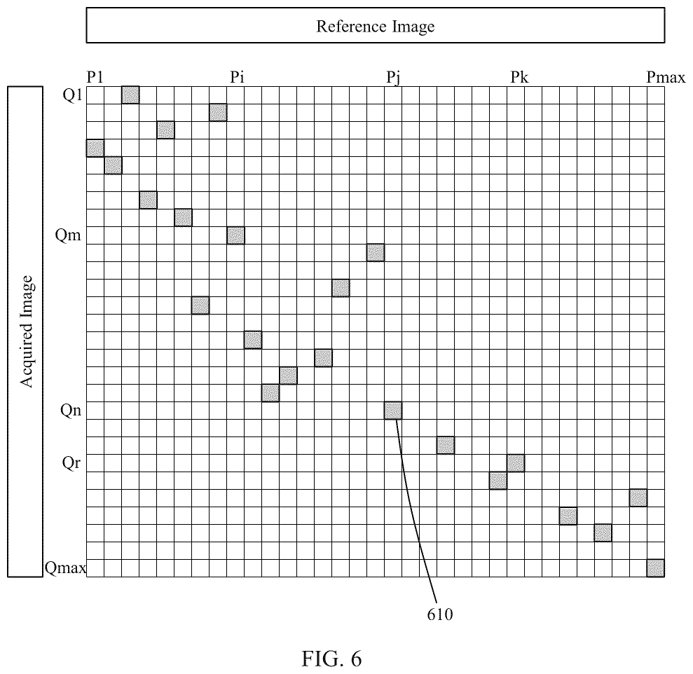

The association between matching hub pixels is represented using a correlation table, as shown in FIG. 6. As can be seen, the correlation table assigns a value that relates the hub pixel number of the reference image with the hub pixel number of the acquired image. Element 610, for example, is assigned a value representing the degree to which the hub pixel Qn in the acquired image matches the hub pixel Pj in the reference image. In the preferred embodiment, the value assigned to an element is based on the number of matching pairs of primary chords that map to the same scale and rotation angle estimate, i.e., the peak in the RAS vote table. In general, the more matching primary chords, the more likely the objects depicted in the acquired and reference images match one another.

Returning to FIG. 4 again, the WIT system in some embodiments is configured to validate 434 the correlation/assignment of hub pixels in the correlation table of FIG. 6. In some embodiments, validation is achieved by performing an affine transformation to map the edge pixels of the object in the acquired image to the reference image using the rotation angle and scale corresponding to the peak in the RAS vote table. If the object, after affine transformation, maps onto the object depicted in the reference image, the match has been validated.

In another embodiment, validation 434 is achieved using chords between pairs of spoke pixels. In particular, the “apparent” or “presumptive” matches between primary chords that radiate from hub pixels can be confirmed by “matching” the secondary chord between two spoke pixels in the acquired image with the “apparent” or “presumptive” counterpart in the reference image. If the transformation relating the two secondary chords exhibit the same scale and rotation angle as the peak in the RAS vote table, the two chords are said to “match”, thus confirming the transform parameters identified by matching primary chords. For example, pixels Pj and Pk are spoke pixels with respect to the hub pixel Pi. Similarly, pixels Qn and Qr are spoke pixels with respect to the huh pixel Qm. If the secondary chord Cjk(R) between pixels Pj and Pk matches the secondary chord Cnr(A) between Qn and Qr with the same scale and/or rotation angle that hub pixel Pi matches hub pixel Qin, then hub pixel Qm is more likely to match hub pixel Pi. In fact, the probability of correct pixel assignments increases each time a secondary chord between two spoke pixels is confirmed to have the same transform parameters (scale and rotation angle) as the peak generated by the hub pixels.

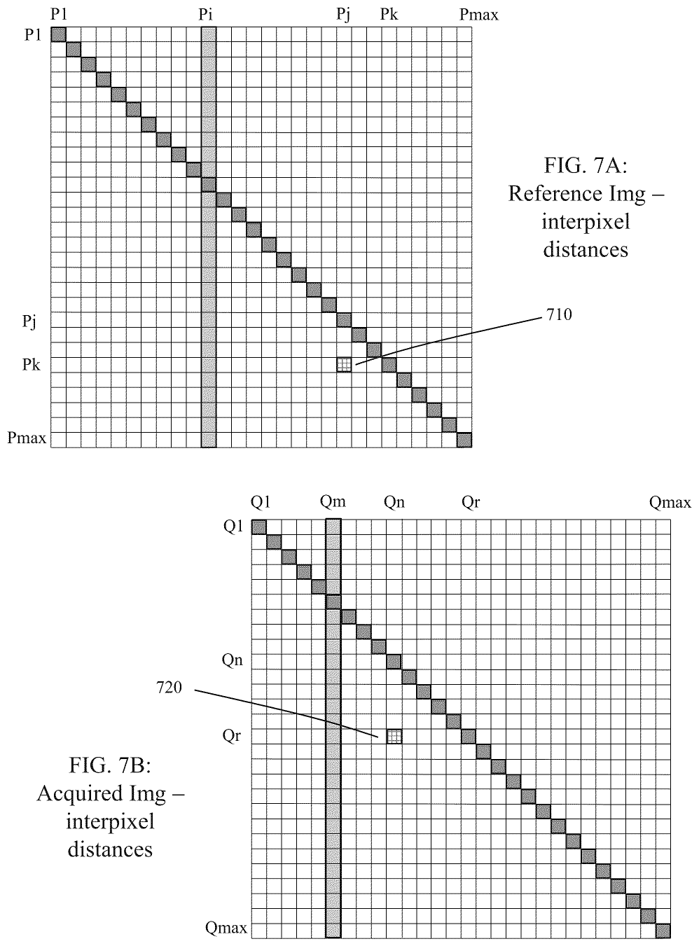

The validation process described immediately above is shown graphically with regard to the tables in FIGS. 7A-713. FIG. 7A shows a table reflecting the inter-pixel distances for every pair of pixels in the reference image. The distance between pixel Pj and pixel Pk is recorded at the element 710 at the intersection between the column corresponding to Pj and the row corresponding to Pk. Similarly, FIG. 7B shows a table of inter-pixel distances for every pair of pixels in the acquired image. The distance between pixel Qn and pixel Qr is recorded at the element 720 at the intersection between the column corresponding to Qn and the row corresponding to Qr.

To determine the relative scale for secondary chords, the WIT system retrieves the distance between spoke pixels Pj and Pk, retrieves the distance between spoke pixels Qn and Qr, and computes the ratio between them. Similarly, the WIT system can estimate the rotation angle based on the difference between a first angle of the chord from pixels Pj to Pk, and a second angle of the chord from pixels Qn to Qr. If the scale and rotation angle between the spoke pixels is the same as the peak determined for hub pixels Pi and Qin, these spoke pixel assignments are effectively validated.

While calculation of the rotation angle is effective for validation, the inter-pixel distances are typically sufficient to confirm the match of the overall shape of the object in the reference image and the object in the acquired image.

Referring back to FIG. 4 again, the WIT system is configured to update the correlation table of FIG. 6 after the validation operation. With the removal of substantially all the noise via the validation operation 434, the correlation table can be regenerated based on matching chords alone. At this stage, the WIT system associates every pixel in the acquired image with a single pixel in the reference image. In view of the high signal to noise ratio, the correlation table generally matches each edge pixel in the acquired image to its proper counterpart pixel in the reference image.

Once the pixel assignments are complete, the WIT system in the preferred embodiment is configured to generate 436 a similarity metric as a measure of the quality of the match between the objects in the reference image and acquired image. In the case of a perfect, match, the similarity metric equals “1”. Anything less than a perfect match gives rises to an error between the chord lengths in the reference image as compared to the chords in the acquired image after transformation into the reference frame of the reference image. In the preferred embodiment, the error is a percentage difference between each reference image chord length and its counterpart chord in the acquired image. If chord Cij(R) corresponds to the first pair of pixels Pi and Pj, and Cmn(A) corresponds to the second pair of pixels Cam and Qn, then the error is (|Cij(R)|−|Cmn(A)|)/|Cij(R)|. This error, in combination with all the error measurements for other chords, is used to compute the similarity between the images. These errors may be averaged or combined using a sum of squares, for example.

If the two objects are identical, the counterpart chord lengths are substantially identical when mapped into the same reference frame and the similarity metric substantially equal to one. If the two objects are different, the errors in counterpart chord lengths result in a similarity metric much less than one.

Upon completion of the review of all pixels in the acquired image, the WIT system outputs 438 a yes-no determination indicating the presence or absence of a recognition based on, for example, the number of matching chords in the vote table, or based on the similarity metric. If the similarity metric is higher than the similarity metric for other reference images, the similarity metric effectively signifies that the object presented in the acquired image is the same as the reference image.

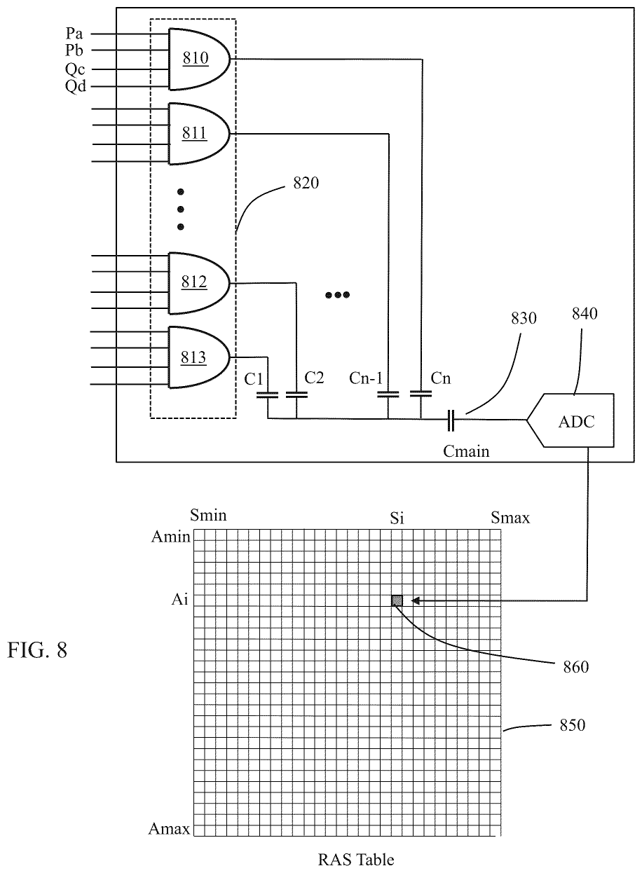

Illustrated in FIG. 8 is a concept for a circuit diagram for implementing portions of the recognition algorithm discussed above. The circuit diagram includes both digital and analog portions which cooperate to detect matching hub pixels and estimate the corresponding scale and rotation angle. In the preferred embodiment, the digital portion includes chord detectors, i.e., AND gates 820, and the analog portion includes a plurality of summing circuits, i.e., capacitors C1-Cn. The digital portion is configured to detect combinations of chords and generate individual votes based on the presence of those chords while the analog portion integrates multiple votes at specific scales and rotation angles.

The digital portion 820 the circuit includes a plurality of AND gates 810-813. Each AND gate 810-813 is configured to detect a first primary chord in the reference image and a second primary chord in the acquired image. The presence of the first chord is detected when two pixels have a value of “1” in the binary reference image, and the second chord is detected when two pixels have a value of “1” in the binary acquired image. If both chords are detected, the AND gate generates a logical “1” or “true” signal. For example, if a first chord corresponds to a hub pixel Pa and spoke pixel Pb, while a second chord corresponds to a hub pixel Qc and spoke pixel Qd, then the AND gate 810 outputs a “true” signal with value “1”. When “true”, the digital circuit effectively generates a “vote” by energizing the capacitor Cn which, in turn, contributes to e charge accumulated at the main capacitor, Cmain.

In addition to the vote from AND gate 810, AND gates 811-813 are configured and/or selected to detect other pairs of chords having the same relative scale and rotation angle. The votes from this set of AND gates 810-813 are then combined by the analog portion of the circuit into a “total.” vote count.

The total number of votes for a set of AND gates is represented in terms of a charge on the main capacitor 830, The voltage across the main capacitor 830—which is proportional to the total number of votes at a particular scale and angle—is measured and the value recorded at the corresponding element 860 of the RAS table 850. In the preferred embodiment, the analog portion is pre-wired to write the total vote count into the RAS vote table at the element corresponding to the scale and rotation angle representing the transform that maps the chord in the acquired image to the chord in the reference image. That is, if the AND gates 810-813 output a “true” signal, their votes are summed up and mapped to the same scale and rotation angle parameters (Si, Ai) in the RAS vote table.

Additional sets of AND gates (not shown) are dedicated to different sets of chords corresponding to different combinations of scale and rotation angle. These votes for other combinations of scale and rotation angle are generated in parallel, their total votes counted/measured by other ADCs (not shown) in parallel, and the vote counts written to the appropriate elements of the RAS vote table in parallel.

When all the votes are written to the RAS vote table, the WIT system identifies the peak in the RAS vote table. If this peak exceeds a predetermined threshold, the WIT system produces a recognition signal along with the determined scale and rotation angle. In other embodiments, the individual votes are counted using a pulse counter (not shown), for example, and the total votes for each combination of scale and rotation angle compared using a digital comparator (not shown) until the peak value is determined. The peak value, in turn, may be compared to the predetermined threshold for purposes of outputting a recognition signal.

As one skilled in the art will appreciate, the recognition of an object as well as the determination of the scale and orientation of the object may be accurately determined in a matter of a small number of cycles of the clock driving the digital portion of the circuit. After identification of the object, the capacitors may be discharged and the circuit reset for the next frame of the video, i.e., the next acquired image.

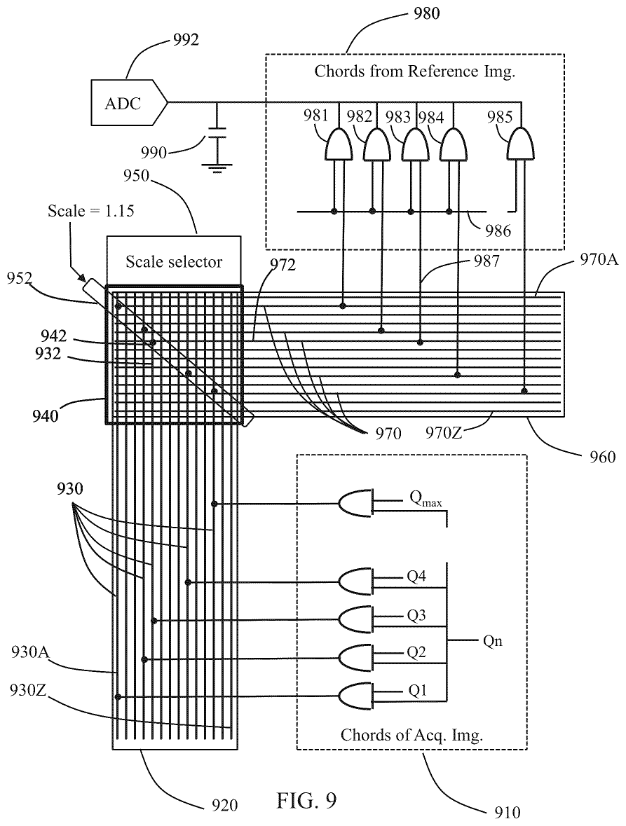

Illustrated in FIG. 9 is a functional block diagram of a WIT system, in accordance with a second embodiment of the present invention. This embodiment includes a circuit configured to perform recognition of an object using only chords to determine the relative scale and/or relative orientation of an object. The presence of chords in the acquired image are determined by logic gates, those chords transformed to candidate chords in other potential reference frames, the candidate chords matched with actual chords in the reference image for a known object, and finally the number of matching chords counted in order to recognize the object.

The second embodiment of the WIT circuit comprises a first bank of chord detectors/generators 910—i.e., AND gates—configured to detect primary chords present in the acquired image, a first data bus 920 for encoding a range of primary chord lengths with data lines 930 and/or angles in the acquired image, a crossbar switch 940 for transforming chord lengths 930 active on the first data bus 920 into other reference frames for different scales and/or rotation angles, a scale selector module 950 for selectively activating transforms within a narrow band of scales and/or angles 952 at any given moment, a second data bus 960 for activating a range of chord lengths encoded by data lines 970 and/or angles generated by the transforms, a second bank of chord detectors/generators—i.e., AND gates 980—for encoding primary chords in a reference image, a summing circuit comprising main capacitor 990 for accumulating a charge proportional to the number of matching chords in the second bank of AND gates 980, and an analog to digital converter (ADC) 992 for reading the voltage across the main capacitor 990.

The first bank of AND gates 910 are configured to detect chords from the acquired image at a single point i.e., a single hub pixel corresponding to the optical axis of the camera or a saccade point of the human visual system. The set of chords, therefore, represents the distances between the hub pixel and all or some of the spoke pixels. In the example shown, the hub pixel is designated Qn and the spoke pixels range from Q1 to Qmax. For each spoke pixel, there is a corresponding AND gate that generates an output signal when the hub pixel and spoke pixel are active, i.e., both have a value of “1” in the high-pass filtered version of the acquired image. The output signals from the first bank of AND gates 910 therefore encode the presence of the chords radiating from Qn.

The lengths of the plurality of output signals from the first bank of AND gates 910 are encoded through their connections with the first bus 920. The first bus 920 includes a plurality of data lines 930 representing different chord lengths 930 and/or angles in the acquired image. Each data line 930 encodes a particular chord length (referred to herein as an “input” chord length), narrow range of chord lengths, or chord length at a particular angle. In this embodiment, the data lines 930 encode chord lengths ranging from smallest possible chord length to largest possible chord length in a sequence running from the left-most data line to the right-most data line, respectively. The smallest possible chord length in the acquired image may be 5 pixels and represented by data line 930A, for example, while the largest possible chord length may be 500 pixels and represented by data line 930Z. Additional data lines 930 may be included to represent or otherwise encode a range of orientation angles for a given chord length.

The second bus 960 also includes a plurality of data lines 970 for encoding chord lengths and/or angles for a reference image. Each data line 970 encodes a particular chord length (referred to herein as an “output” chord length), narrow range of chord lengths, or chord length at a particular angle. In this embodiment, the data lines 970 encode a chord length from smallest to largest in a sequence finning from the top-most data line to the bottom-most data line, respectively. The smallest possible chord length in the acquired image may be 6 pixels and represented by data line 970A, for example, while the largest possible chord length may be 600 pixels and represented by data line 9702, Additional data lines 970 may be included to represent or otherwise encode a range of orientation angles for a given chord length.

The data lines of the first bus 920 and second bus 960 intersect at the crossbar switch 940. The crossbar switch 940 is configured to emulate the transform for each pair of data lines 930, 970. For example, the data line 932 intersects the data line 972 at point 942 coinciding with one of a plurality of transforms. If data line 932 encodes an input chord length of d1 and data line 972 encodes an output chord length of d2, then the transform corresponds to the scale equal to d2/d1. If the data lines 930, 970 also encode rotation angle, the transform also represents an angle equal to the difference of the angle of the chord encoded by data line 932 and the angle of the chord encoded by data line 972.

If and when that particular scale, i.e., d2/d1, is selected in the manner described below, the crossbar switch 940 outputs a “true” signal on data line 972 in order to activate any chords in the reference image that have length d2. If data lines 932, 972 encode orientation as well as chord length, the crossbar switch 940 outputs a signal on a data line that encodes the particular orientation and chord length in order to activate any chords in the reference image that have length d2 at the selected orientation.

As described, the crossbar switch 940 includes a plurality of transforms, each transform corresponding to a pair of data lines 930, 970 that encode a chord pair comprising an input chord length and output chord length, respectively. The scale selector module 950 is configured to selectively enable transforms based on the scale and/or rotation angle associated with the transform. In particular, the scale selector module 950 is configured to sweep through a wide range of scales/rotation angles and enable only a narrow band of scales/rotation angles 952 for output on the data lines 970 at any given moment.

The set of scales as computed by transforms 942, for example, may span an order of magnitude or more. The scale selector module 950, operatively coupled to multiple the crossbar switch 940, is configured to select only a small subset of that range of scales at any given moment as it sweeps the entire range of scales. Over the course of a predetermined period of time, preferably a fraction of a second, the scale selector module 950 is configured to sweep through the entire range from a minimum scale to maximum scale.

At each instance, the scale selector module 950 is configured to select a current/instantaneous scale and identify all the points of intersection between the first bus 920 and second bus 960 whose ratio, i.e., estimated scale, is equal to the current scale (or within a small deviation of the scale) activated by the scale selector module 950. When the scale associated with a transform matches the instantaneous scale of the scale selector module 950, the scale selector module causes the particular data line on the second bus 970 to have a value of “1”. At this moment in the sweep of the scales, a data line on the second bus 960 is active if an only if the particular chord length represented by the second bus 960 can be generated by a transform of a chord length represented on the first bus 920 at the particular scale selected by the scale selector module 950 at that moment. The set of identified transforms that exhibit the selected scale are within a box 954, which corresponds to a scale of 1.15, for example, at that instance.

As one skilled in the art will appreciate, when the object in the acquired image is the same as the object in the reference image, albeit at a different scale and rotation angle, each of the primary chords represented in the data lines of the second bus 960 has a counterpart chord in the data lines of the first bus 930. While the chords encoded in the second bus 960 have a different scale than their counterpart chords encoded in the first bus 930, the scale is the same for each pair of counterpart chords. Thus, when the scale selector module 950 sweeps to that particular scale, it enables the plurality of transforms that concurrently activate the set of counterpart chords among the data lines of the second bus 960. When active at the same time, the set of counterpart chords among the data lines of the second bus 960 activate a set of logic gates representing the counterpart hub pixel in the reference image in the manner described below.

The second embodiment of the WIT circuit further includes a second bank of chord detectors/generators 980—i.e., AND gates—configured to encode the chords of an object depicted in a reference image. Each of the AND gates 981-985 corresponds to one of the primary chords that radiates from a hub pixel depicted in the reference image. Each individual AND gate includes two inputs. The first input, represented by circuit 986, can be activated to select the particular hub pixel. The second input to each AND gate is then used to select a particular spoke pixel in the reference image. The combination of each hub pixel and spoke pixel corresponds to a particular chord, and the length of that chord encoded in the connection to the appropriate data line 970 in the second bus 960.

AND gate 983, for example, is first selected based on a hub pixel associated with input 986, and then fully activated when the chord length associated with input 987 is present and energized by the scale selector module. In response, AND gate 983 outputs a signal of value “1” to indicate the presence of a possible chord matching a counterpart chord in the acquired image at the selected scale.

If all the AND gates 981-985 have counterpart chords at that selected scale, all the AND gates are activated which, in turn, induces a large charge on the main capacitor 990. The total charge on the main capacitor 990 is roughly proportional to the number of matching chords in the second bank 980 of AND gates.

The total charge corresponds to a voltage that is then read out by the ADC 992. If the voltage read by the ADC 992 exceeds a predetermined threshold, the ADC has effectively confirmed the presence of an object in the acquired image that matches the object in the reference image. The detection signal can then be transmitted to other computing modules in order to, tor example, decide on the next action to take with respect to the mobile robot or vehicle.

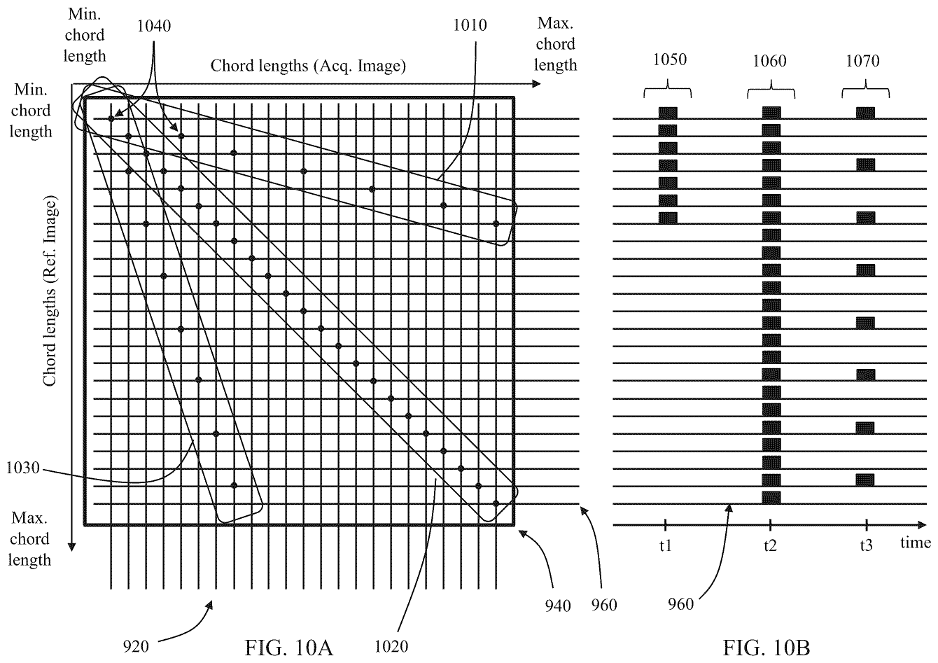

Illustrated in FIG. 10A is a diagrammatic representation of the function of the scale selector module 950 and crossbar switch 940. As discussed herein, the crossbar switch 940 is coupled to the first data bus 920 and the second data bus 960. The intersection of the plurality of data lines 930 of the first data bus 920 with the plurality of data lines 970 of the second data bus 960 give rise to a plurality of nodes. As such, each node is associated with one data line 930 and one data line 970. Since the data line 930 is associated with a chord length in the acquired image, and the data line 970 is associated with a chord length in a reference image, each node is associated with two chord lengths. The ratio of these two chord lengths is a scale representing the transform needed to convert the chord length from the acquired image space to the reference image space. Each node is, therefore, a “transform node” or “transform” characterized by an estimated scale for converting the input chord length to the output chord length. The entire set of nodes generally gives rise to a wide range of estimated scales for purposes of testing for an object over a wide range of sizes/orientations in the acquired image.

In order to select a subset of chords for input to the second bank of AND gates 980, the scale selector module 950 actives a subset of nodes/transforms having a narrow band of scales at any given time as it sweeps through the entire range of scale. If the instantaneous scale selected is equal to 0.5, for example, the scale selector module 950 activates the set of nodes/transforms within the box 1010, which correspond to a relatively large object in the acquired image and relatively small object in the reference image. When selected, a subset of the data lines 960 are activated in order to activate the AND gates encoding the counterpart chords in the reference image.

Similarly, if the instantaneous scale selected is equal to 1.0, for example, the scale selector module 950 activates the set of nodes within the box 1020, Which correspond an object of equal size in the acquired image and reference image. When this subset of nodes/transforms is selected, a subset of the data lines 960 are activated in order to activate the AND gates encoding the counterpart chords in the reference image. If the instantaneous scale selected is equal to 2.0, for example, the scale selector activates the set of nodes/transforms within the box 1030, which correspond to a relatively small object in the acquired image and relatively large object in the reference image. When these nodes are selected, a subset of the data lines 960 are activated in order to activate the AND gates encoding the counterpart chords in the reference image.

FIG. 1013 is a diagrammatic representation of output signals from a crossbar switch as it sweeps through a range of scales. When a transform node 942 is activated by the scale selector module 950, the transform node causes a “true” signal to be outputted on the associated data line 970 where it can energize any chords of that particular length in the reference images/models, To be activated, the input data line 930 associated with the node 942 must be “true” and the instantaneous scale of the scale selector module 950 must be equal or nearly equal to the scale associated with the node.

When the scale selector module 950 activates a set of nodes within the box 1010, for example, a subset of the data lines are concurrently activated. This set of active nodes or “transforms” is represented by the set of “true” signals 1050 on data lines 970. When the scale selector module 950 activates a set of nodes within the box 1020, for example, another subset of the data lines are concurrently activated. This set of active nodes or “transforms” is represented by the set of “true” signals 1060 on data lines 970. And when the scale selector module 950 activates a set of nodes within the box 1030, for example, a different subset of the data lines are concurrently activated. This set of active nodes or “transforms” is represented by the set of “true” signals 1070 on data lines 970. After the scale selector module 950 has complete the sweep of the range of scales, the set, of chords from a reference image/model is activated if and when the counterpart chords in the acquired image are transformed at the specific scale and/or angle needed to transform the object in the acquired image to the same object in the reference image.

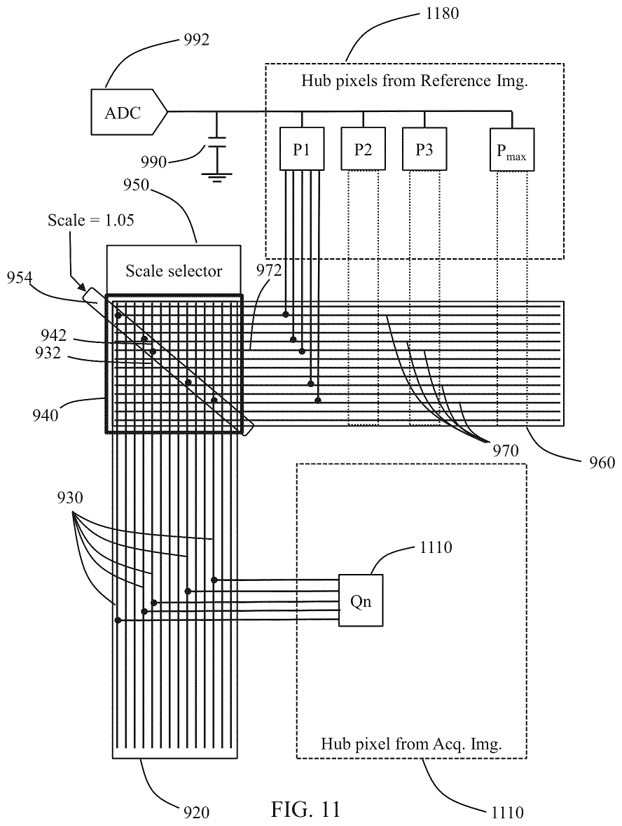

Illustrated in FIG. 11 is a third embodiment of the present invention. This embodiment includes a circuit configured to perform recognition of an object using only a set of features consisting of chords to determine the scale and rotation angle of an object in an acquired image. The presence of chords in the acquired image are determined by neuromorphic nodes (instead of AND gates alone), those chords transformed into other reference frames based on a range of scales, chords in the reference image selectively activated based on the transforms, and the object in the reference image finally recognized based on the actual chords extracted from the reference image for a given scale.

The third embodiment of the WIT circuit comprises a plurality of chord detectors/generators including a first bank of neuromorphic nodes 910 configured to detect chord lengths from the acquired image, a first bus 920 for encoding a range of chord lengths 930 and/or angles in the acquired image, a crossbar switch 940 for emulating transforms at particular scales, a scale selector module 950 for selecting transforms within a narrow band of scales 952 at any given moment, a second bus 960 for encoding a range of chord lengths 970 and/or angles in the reference image, a second bank of chord detectors/generators including neuromorphic nodes for detecting/generating chords in a reference image, a main capacitor 990 for accumulating a charge proportional to the number of matching chord pairs in the second bank of neuromorphic nodes 980, and an ADC 992 for reading the voltage across the main capacitor 990. The first bus 920, crossbar switch 940, scale selector module 950, second bus 960, main capacitor 990, and ADC 992 operate in the same manner as discussed here in context of FIG. 9.

In this embodiment, the neuromorphic node(s) 1110 replaces the first bank of AND gates, and second bank of neuromorphic nodes 1180 replaces the second bank of AND gates 980.

With regard to the acquired image, the neuromorphic node 1110 is generally activated when the optical axis of the camera, for example, is placed on the hub pixel Qn. The neuromorphic node 1110 is, in turn, configured to activate a plurality of data lines 930 corresponding to primary chords lengths in the acquired image. Activation of the node effectively activates all the chords that radiate from pixel Qn.

With regard to the reference image, the neuromorphic nodes P1-Pmax are configured to emulate neurons in the human visual system. Each node P1-Pmax includes a plurality of inputs wired to a particular data line 970 representing primary chord lengths in a reference image. When a node P1-Pmax is the counterpart to the node Qn, most if not all the chords represented in the second bus 960 have a counterpart chord activated in the first bus 920. When the scale selector module 950 sweeps to the correct transform scale, most if not all the chords represented in the second bus 960 activate, in turn, an input to the counterpart hub in the set of nodes, P1-Pmax.

In the preferred embodiment, the nodes P1-Pmax correspond to a plurality of edge pixels in a single reference image. However, many other reference images can be wired to the second bus 960 in the same manner, thus enabling the WIT circuit to detect numerous hub pixels in numerous objects in a massively parallel manner.

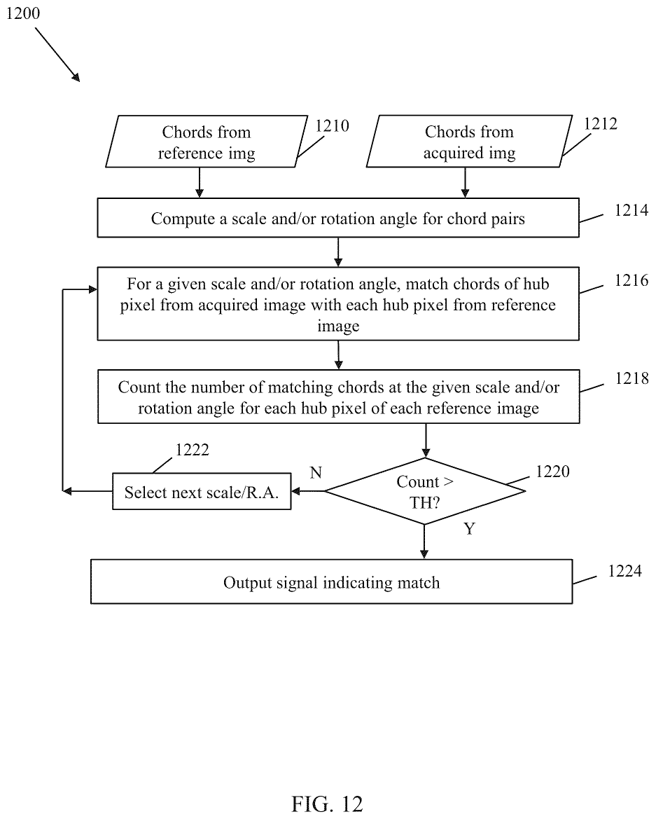

Illustrated in FIG. 12 is a flowchart of the process of doing object recognition using either the second or third embodiment of the WIT circuit described herein. To start, the WIT system (a) provides 1210 chords lengths and/or angles corresponding to a particular hub pixel in the reference image, and (b) provides 1212 the chords lengths and/or angles corresponding to a particular hub pixel in the acquired image. The circuit then computes 1214 estimated scales and/or angles based on each one of the primary chords from the reference image in combination with each one of the primary chords from the acquired image. For a select scale, the WIT system matches 1216 the chords associated with one of more hub pixels in the reference image with the chords associated with a hub pixel in the acquired image for the selected scale and/or rotation angle. The number of matches is then counted 1218.

If the number of counts fails to exceed a pre-determined threshold, decision block 1220 is answered in the negative, and the WIT system continues on to select 1222 a different scale. If the number of counts exceeds the pre-determine threshold, the decision block 1220 is answered in the affirmative, and the WIT system outputs 1224 a signal indicating a match between the object in the acquired image and reference image.

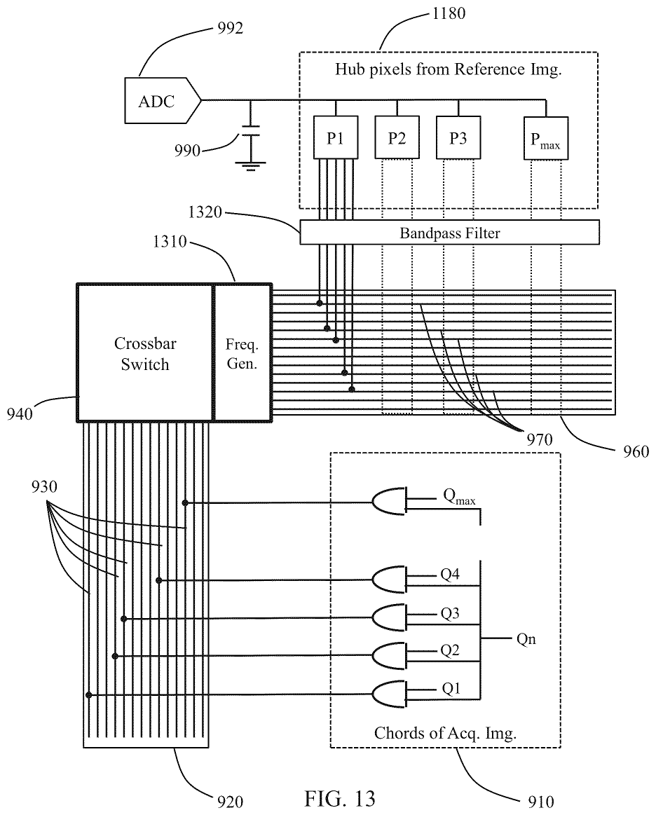

Illustrated in FIG. 13 is a fourth embodiment of the present invention. As described herein, this embodiment includes a circuit configured to perform recognition of an object using only chords to determine the scale and rotation angle of an object in an acquired image. In addition, the present embodiment uses frequency encoding to transmit chord information for multiple scales concurrently, i.e., without the scale sweeping implemented by the scale selector module 950.

The fourth embodiment of the WIT circuit comprises a first bank of chord detectors/generators—i.e., neuromorphic nodes or logic gates 910 configured to encode specific chord lengths from the acquired image, a first bus 920 for encoding a range of possible chord lengths 930 and/or angles in the acquired image, a crossbar switch 940 for emulating transforms over a range of scales and/or angles, a frequency generator 1310 for modulating a carrier frequency used to transmit chord data, a second bus 960 for encoding a range of possible chord lengths 970 and/or angles in the reference image, a bandpass filter to filter out low level chord data based on frequency data and pass high level chord data, a second bank of chord detectors/generators—neuromorphic nodes—for encoding chord lengths in a reference image, a main capacitor 990 for accumulating a charge proportional to the number of matching chords in the second bank of neuromorphic nodes 980, and an ADC 992 for reading the voltage across the main capacitor 990. The first bus 920, crossbar switch 940, second bus 960, main capacitor 990, and ADC 992 operate in the same manner as discussed here in context of FIG. 9.

The present embodiment modulates the outputs of the transforms in the crossbar switch 940 to the second bus 960 with a frequency generator 1310, each scale or scale range corresponding to a different frequency. A bandpass filter 1320 is then used to filter out chords if the number of chords at a particular frequency, i.e., scale, fall below a predetermined threshold. However, when the number of chords at a frequency is above the threshold, the chords are passed by the filter 1320 and transmitted through to the neuromorphic nodes 1180 that detect the presence of a counterpart hub pixel in the reference image that matches the hub pixel represented by the logic gates 910.

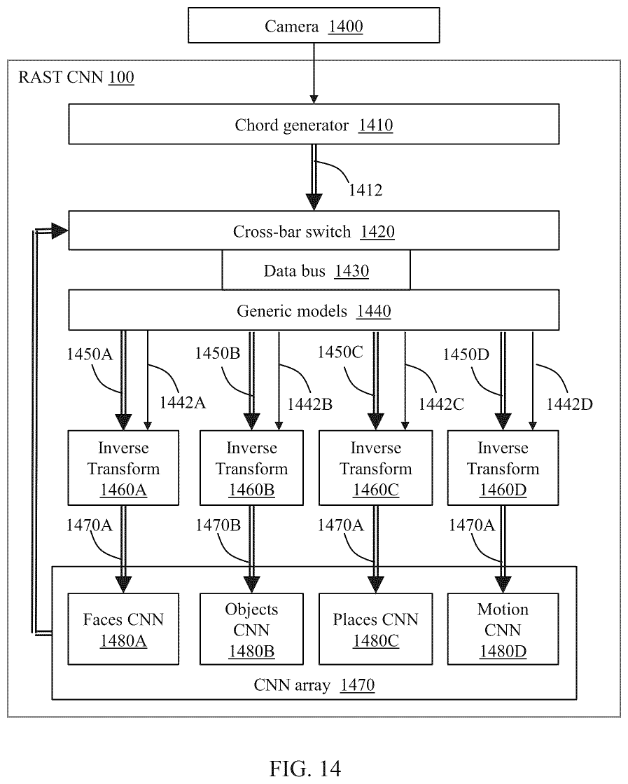

Illustrated iii FIG. 14 is functional block diagram of a system for performing object recognition using a combination of WIT for automatically compensating for scale and rotational invariance in conjunction with convolution neural networks (CNNs), The system, referred to herein as the invariance-corrected CNN or IC-CNN, includes a camera 1400, chord generator 1410, crossbar switch 1420, data bus 1430, a plurality of generic models 1440, inverse transform modules 1460A-1650D, and detailed models encoded in an array of CNNs 1470 including a Faces CNN 1480A, Objects CNN 1480B, Places CNN 1480C, and Motion CNN 1480D.

In this embodiment, image data is generated by one or more cameras 1400. After edge detection, the edge pixel data is transmitted to a module 1410 configured to generated a plurality of chords corresponding to a plurality of hub pixels. The chords corresponding to one or more hub pixels are transmitted to a cross-bar switch 1420 which is configured to sweep through a range of scales in the manner described herein and output transformed versions of the chord lengths on the data bus 1430. The output chord lengths are provided as input to a plurality of models for preliminary recognition. A generic model as used herein refers to a generalized version of one or more objects. A generic model of a face, for example, is configured to detect a large variety, i.e., a class, of faces rather than one specific face.

When a generic model is detected by the module 1440, the chords 1450A-1450D of the input image that triggered the module 1440 are subjected to an inverse transformation in order to represent those chords at the scale and orientation angle 1442A-1442D of the generic model. If a face is at a different scale and orientation angle 1442A as the generic model, for example, the chords 1450A of the face are transformed so that the representation of the face is vertical and the scale is a uniform scale as the model. This inverse transformation is performed by module 1460A. The other inverse transform modules 1460B-1460D perform the same function but for different models.

After the chords that represent a face, tor example, are transformed into a common coordinate system, an image 1470A of the face is transmitted to the Face CNN 1480 where the image is used to train one or more filter kernels specifically dedicated to the representations of faces. Since all the faces in the face data are at a common scale and rotation angle, the number of filter kernels necessary to represent the set of learned faces is substantially reduced. That is without the inverse transform by the module 1460 the number of filter kernels needed to represent those same faces at a variety of different scales and orientation angles would be substantially larger. The same is true of the other objects represented in the object CNN 1480B, the motion CNN 1480C, and places CNN 1480D.

The present invention is inspired by the human visual system, specifically the ventral visual pathway comprising areas V1, V2, V4, and IT of the visual cortex. As a result, the present invention has a number of qualities that parallel the human brain. Like area V1, the present invention relies on edge detection to discern the shape of objects. Like area V2, the present invention combines individual edge sensors into more complex contours. Although V2 is known to produce corner features from these edge sensors, it is plausible to think that edge sensors separated by distance may be combined to create chords in a manner similar to that of AND gates 910. The chords, in turn, may be clustered together in the cortex based on their length and retinotopic position like the data bus 920, for example. The chords may also be adapted to sense motion, specifically velocity, based on the distance between the two edge sensors as well as the time elapsed between firing of those edge sensors. And area V4, although shrouded in mystery, may include an array of pre-wired transforms configured to map input chord lengths to output chord lengths based on scale and rotation angle estimates. The output chord lengths may then be laid out and organized based on their length and orientation, thereby enabling area IT to aggregate chord lengths into a memory of a person or object, for example. Since only one exposure to an objected in needed to encode the memory, the WIT ca be characterized as a one-shot learning system. After the memory is encoded, the person or object may be recognized by concurrently matching multiple chord lengths like AND gates 980. When a sufficient number of chords are matched, one or more components may output a signal confirming the presence of the known object within the visual field of view, much like the capacitor 990 which is configured to emulate a “grandmother” cell.

One or more embodiments of the present invention may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The term processor as used herein refers to a number of processing devices including personal computing devices, mobile phones, servers, general purpose computers, special purpose computers, central processing units (CPUs), graphics processing units (GPUs), application-specific integrated circuits (ASICs), spiking neural networks (SNNs), analog processing units, and digital/analog electronic circuits with discrete components, for example.

Although the description above contains many specifications, these should not be construed as limiting the scope of the invention but as merely providing illustrations of some of the presently preferred embodiments of this invention.

Therefore, the invention has been disclosed by way of example and not limitation, and reference should be made to the following claims to determine the scope of the present invention.

I claim:

1. A system for performing object recognition based on an acquired image and a reference image, the system comprising:
an edge detector configured to:
a) detect a plurality of edge pixels in the acquired image; and
b) detect a plurality of edge pixels in the reference image;
a plurality of transforms, each transform associated with an input chord length and an output chord length, wherein each transform is characterized by a scale based on a ratio of the associated input and output chord lengths;
a chord generator coupled to the edge detector and plurality of transforms, wherein the chord generator is configured to generate:
a) a first plurality of chords, each chord characterized by a length between two of the plurality of edge pixels in the acquired image; wherein each of the first plurality of chords is coupled to at least one of the plurality of transforms based on the associated input chord length; and
b) a second plurality of chords, each chord characterized by a length between two of the plurality of edge pixels in the reference image; wherein each of the second plurality of chords is coupled to at least one of the plurality of transforms based on the associated output chord length; and
a summing circuit coupled to the second plurality of chords, wherein the summing circuit is configured to:
a) for each of a plurality of scales, determine a number of chords from the second plurality of chords that have a counterpart chord among the first plurality of chords; and
h) output a recognition signal if and when the number exceeds a predetermined threshold for one of the plurality of scales.

2. The system of claim 1, further comprising a scale selector module configured to:
a) sweep through the plurality of scales; and
b) while sweeping through the plurality of scales, activate one or more of the plurality of transforms based on the associated scale.

3. The system of claim 1, further comprising:
a first data bus connecting each of the first plurality of chords with at least one of the plurality of transforms based on the associated input chord length; and
a second data bus connecting each of the second plurality of chords with at least one of the plurality of transforms based on the associated output chord length;

4. The system of claim 1, Wherein the chord generator comprises a plurality of AND gates, wherein each AND gate is configured to receive a first binary value associated with a first pixel and a second binary value associated with a second pixel; wherein each AND gate is configured to output a “true” signal if the first pixel and second pixel are both edge pixels.

5. A system for performing object recognition based on an acquired image comprising a plurality of edge pixels and at least one reference image comprising a plurality of edge pixels, the system comprising:
a plurality of transforms, each transform associated with an input chord length and an output chord length, wherein each transform is characterized by a scale based on a ratio of the associated input and output chord lengths;
a feature detector configured to generate:
a) a first set of features consisting of a first plurality of chords, each of the first plurality of chords characterized by a length between two edge pixels in the acquired image; wherein each of the first plurality of chords is coupled to at least one of the plurality of transforms based on the associated first chord length; and
b) a second set of features consisting of a second plurality of chords, each of the second plurality of chords characterized by a length between two edge pixels in the reference image; wherein each of the second plurality of chords is coupled to at least one of the plurality of transforms based on the associated second chord length;
a summing circuit coupled to the second plurality of chords, wherein the summing circuit, is configured to output a number of the first plurality of chords that map to one of the second plurality of chords via one or more of the plurality of transforms that are characterized by a current scale.

6. The system of claim 5, further comprising a scale selector module configured to:
select the current scale from a sequence comprising a plurality of scales;
activate any of the plurality of transforms characterized by a scale equal to the current scale;
wherein the summing circuit is configured to output a number of input chords that map to an output chord for each scale of the plurality of scales.

7. The system of claim 5, wherein the summing circuit comprises an analog to digital converter and plurality of capacitors for integrating signals from the second plurality of chords, wherein the signals correspond to the number of first plurality of chords that map to one of the second plurality of chords via one or more of the plurality of transforms that are characterized by a current scale.

8. The system of claim 5, wherein the summing circuit comprises at least one pulse counter for counting signals from the second plurality of chords, wherein the signals correspond to the number of first plurality of chords that map to one of the second plurality of chords via one or more of the plurality of transforms that are characterized by a current scale.

9. The system of claim 5, further comprising a frequency generator configured to:
generate a plurality of modulation signals, one modulation signal for each of a plurality of scales including the current scale;
modulate an output from each of the plurality of transforms based on the associated scale.

10. The system of claim 9, further comprising a bandpass filter configured to pass the outputs of a portion of the plurality of transform if and when those outputs are characterized by a common modulation frequency and the number of outputs is maximal.

11. The system of claim 5, further comprising a data bus configured to connect each of the second plurality of chords with at least one of the plurality of transforms.

12. The system of claim 11, Wherein the data bus is configured to connect to the second plurality of chords; wherein the second plurality of chords correspond to a plurality of reference images, whereby a plurality of objects can be searched in parallel.

13. The system of claim 12, further comprising a data bus configured to connect each of the first plurality of chords with at least one of the plurality of transforms.

14. The system of claim 13, Wherein first plurality of chords consists of primary chords.

15. The system of claim 14, further comprising a verification module for verifying at least one of the plurality of primary chords based on a plurality of secondary chords.

16. The system of claim 5, further comprising:
an inverse transform module configured to transform the first plurality of chords to a predetermined reference frame, and generate an image with the first plurality of chords to a predetermined reference frame; and
at least one convolutional neural network configured to receive the image generated from the first plurality of chords to a predetermined reference frame.

17. A method of performing object recognition based on an acquired image comprising a plurality of edge pixels and at least one reference image comprising a plurality of edge pixels, the method comprising:
generating a first plurality of chords, each of the first plurality of chords characterized by a length between two edge pixels in the acquired image; wherein each of the first plurality of chords is coupled to at least one of the plurality of transforms based on the associated chord length;
generating a second plurality of chords, each of the second plurality of chords characterized by a length between two edge pixels in the reference image; wherein each of the second plurality of chords is coupled to at least one of the plurality of transforms based on the associated chord length;
generating an estimated scale tor a plurality of chord pairs, each chord pair comprising one of the first plurality of chords and one of the second plurality of chords;
selecting one of a plurality of scales;
determining a number of chord pairs correspond to said one of the plurality of scale;
if and when the number exceeds a predetermined threshold, then output a recognition signal.

18. The method of claim 17, further comprising:
a) extracting a plurality of edge pixels from the acquired image; and
b) extracting a plurality of edge pixels from the reference image.

19. The method of claim 18, further comprising:
generating an estimated rotation angle for each of the plurality of chord pairs; and
determining a number of chord pairs corresponding to said one of the plurality of scales and one of the plurality of estimated rotation angles.
